(19) United States
(12) Patent Application Publication
(10) Pub. No.: US 2013/0003072 A1
(43) Pub. Date: Jan. 3, 2013

(54) FIELD-COMPENSATED INTERFEROMETER

(76) Inventors: Christian Buil, Castanet (FR); Laurence Buffet, Saint Orens (FR); Bruno Belon, Toulouse (FR); Cyril Degrelle, Mandelieu (FR); Christophe Buisset, Bar Sur Loup (FR); Denis Simeoni, Le Rouret (FR)

(21) Appl. No.: 13/393,806

(22) PCT Filed: Aug. 30, 2010
(86) PCT No.: PCT/EP2010/062651

§ 371 Date: Sep. 20, 2012

(30) Foreign Application Priority Data
Sep. 4, 2009 (FR) 0956051

(51) Int. Cl. G01B 9/02

(52) U.S. Cl. 356/450

(57) ABSTRACT

The invention relates to a field-compensated interferometer (1) including an optical assembly (2) for directing incident light beams (4) having a field angle θ relative to an optical axis of the interferometer (1), into arms (5, 6) of the interferometer, and a beam splitter (12), the arms (5, 6) including at least one mechanically movable optical device (15, 16) for generating a variable optical path difference between beams generated by the separation of each incident beam (4) using said beam splitter (12), said interferometer (1) being characterized in that it includes at least one field compensation optical element (E) arranged in one or the other of the image focal planes of the optical assembly (2), said image focal planes being combined relative to the beam splitter (12), said element (E) including at least one surface (9) that is curved so as to generate a path difference between the incident beams having a non-zero field angle and the incident beams having a zero field angle, the generated path difference making it possible to compensate for the self-apodization resulting from the field angle.

### GENERAL TECHNICAL FIELD

The invention relates to an interferometer and to an interferometry method in the field of Fourier transform interferometers with two mirrors. More specifically, the invention relates to field compensation in this type of instrument.

### STATE OF THE ART

Fourier transform interferometers with two mirrors (also designated according to the expression of “FTS” for Fourier transform spectrometer) are commonly used in interferometry, and notably find applications in spectrometry, such as for example infrared spectrometry.

In this type of instrument, distinct light beams, stemming from the separation of an incident light beam, cover different optical paths in portions of the interferometer, also called “arms” of the interferometer most often two in number.

With the recombination of the distinct beams, it is then possible to obtain an interferogram, measured by a detector, resulting from the optical path difference between said beams.

A variable path difference is generally generated by displacing one or more mechanically mobile optical devices in the arms of the interferometer.

A fundamental criterion for examining the performance of an interferometer is its spectral resolution, i.e. its capability of separating without any ambiguity two contiguous spectral elements.

The spectral resolution is all the higher since the path difference generated between the arms of the interferometer is high. In particular the spectral fineness is equal to the reciprocal of the path difference generated between the arms of the interferometer.

Nevertheless, the increase in the path difference is subject to certain limitations in the instruments of the prior art.

When the incident light beams have a non-zero field angle θ relatively to the optical axis of the interferometer, resulting from the angular field of the observed scene (for example an area of the surface of the Earth), said beams will cover an optical path with a different length relatively to the incident light beams at the optical axis, which themselves have a zero field angle θ.

The real path difference 5 is then a function of the field angle θ. In an interferometer of the Michelson type, the variable real path difference 5, depending on the field angle θ is written as: δ=δ′ cos(θ), wherein δ is the path difference generated along the optical axis via the movable optical device in the arms of the interferometer, and θ is the field angle.

Accordingly, each incident light beam stemming from a point of the field produces its own interferogram, different from another light beam, which blurs the interferogram measured by the detector and reduces its contrast.

The greater is the path difference δ′ generated between the arms of the interferometer via the movable optical device, the more the contrast will decrease with the field, until it cancels out in certain cases.

This phenomenon is known to the person skilled in the art under the name of self-apodization.

The spectral resolution is therefore limited by the angular aperture of the instrument, i.e. its field of view.

An interferometer according to the prior art is illustrated in FIG. 1 (taken from “Chemical infrared Fourier transform spectroscopy”), Peter R. Griffiths, John Wiley, London, N.Y., Sydney and Toronto, 1975, p. 127), in order to attempt to overcome the aforementioned problems, i.e. for compensating for the field presence which causes an undesired path difference.

The interferometer comprises a semi-reflective beam splitter 12 capable of separating the incident light beam 4, having a field angle θ relatively to an optical axis of said interferometer, towards two arms 5, 6 of the interferometer, each comprising a prism 18, 19, one of the surfaces of which is reflective. The path difference between both arms 5, 6 of the interferometer is obtained by moving one of the prisms 18 along the axis 20. Field compensation is obtained by the covered substantially constant distance in the prism regardless of the field angle.

The drawback of the solution is that it uses parallel beams, which requires for field compensation, very large prisms, with the size of the entrance pupil, enhancing the bulkiness of the interferometer.

Another drawback of this solution is that it suffers from chromatism due to the light beam crossing very thick prisms.

Another further drawback relates to the displacement of the heavy and bulky prism, which is accomplished over large distances (of the order of 5 cm) which poses fundamental problems for positioning and maintaining the prism along the displacement axis.

### PRESENTATION OF THE INVENTION

The invention proposes to overcome at least one of these drawbacks.

For this purpose, the invention proposes a field-compensated interferometer, comprising an optical assembly capable of directing incident light beams having a field angle θ relative to an optical axis of the interferometer into arms of the interferometer, a beam splitter, the arms comprising at least one mechanically movable optical device for generating a variable optical path difference between beams stemming from the separation of each incident beam via said beam splitter, said interferometer being characterized in that it comprises at least one field compensation optical element, arranged in either one of the image focal planes of the optical assembly combined relatively to the beam splitter, said element comprising at least one curved surface so as to generate a path difference between the incident beams having a non-zero field angle and the incident beams having a zero field angle, the thereby generated path difference making it possible to compensate for the self-apodization resulting from the field angle.

The invention is advantageously completed by the following features, taken alone or in any of their technically possible combinations:
the interferometer comprises two field compensation optical elements respectively arranged in each of the two image focal planes of the optical assembly, combined relatively to the beam splitter;
the surface of the optical element is curved on at least one of its meridians;
the interferometer comprises two optical elements, one of the elements comprising a curved surface on a first meridian, the other one of the elements comprising a curved surface on a second meridian, the first and the second meridian being orthogonal;
the optical element is a mirror, said mirror comprising a reflective curved surface on at least one of its meridians;
the reflective curved surface of said mirror has a continuously curved mechanical profile;
the reflective curved surface of said mirror has a mechanical profile consisting of a discrete set of reflective planar surfaces;
the interferometer comprises means for rotating reflective planar surfaces;
the optical element is a thin mirror, deformable via a deformation system;
the deformation system is a piezo-electric system;
the interferometer comprises a laser metrology tool for controlling the displacement generated by means for displacement or deformation generated by the deformation system;
the optical field compensation element is a thin glass plate;
the interferometer comprises two field compensation optical elements: a thin glass plate and the beam splitter, arranged at the image focal plane of the optical assembly.

The invention also proposes a method for field-compensated interferometry in an interferometer in which an optical assembly directs incident light beams into the arms of the interferometer, the mechanically movable optical device is displaced in order to generate a path difference between the beams stemming from the separation of each incident beam, the recombination of which makes it possible to apply the interferometry, said method being characterized in that it comprises the step according to which the reflective planar surfaces of the mirror are displaced in rotation simultaneously with the optical device by an angle compensating the path difference generated by the displacement of said optical device.

The invention finally proposes a method for field-compensated interferometry in an interferometer, in which an optical assembly directs incident light beams into the arms of the interferometer, a mechanically movable optical device is displaced in order to generate a path difference between the beams stemming from the separation of each incident beam, the recombination of which makes it possible to apply interferometry, said method being characterized in that it comprises the step according to which the surface of the thin mirror is deformed simultaneously with the optical device by a distance compensating the path difference generated by the displacement of said optical device.

The invention has many advantages.

An advantage of the invention is that it allows self-apodization to be reduced and even cancelled out.

Another advantage of the invention is that it proposes an achromatic solution.

Another further advantage of the invention is that it allows reduction in the size of certain critical optical elements of the instrument with a given spectral resolution.

Another further advantage of the invention is that it allows an increase in the field of view of the instrument with a given spectral resolution.

Another further advantage of the invention is that it allows an increase in the general efficiency of the interferometer, which may be defined as the product of the spectral resolution by the luminosity.

Finally, another advantage of the invention is that it applies small displacements of optical elements for compensating the field.

### PRESENTATION OF THE FIGURES

Other features, objects and advantages of the invention will become apparent from the description which follows, which is purely illustrative and non-limiting, and which should be read with reference to the appended drawings wherein:

FIG. 1, for which comments have already been made, is an interferometer according to the prior art;

FIG. 2 is a schematic view of a field-compensated interferometer according to the invention;

FIG. 3 is a sectional view of a mirror for field compensation;

FIG. 4 is a schematic view of another embodiment of a field-compensated interferometer according to the invention.

### DETAILED DESCRIPTION

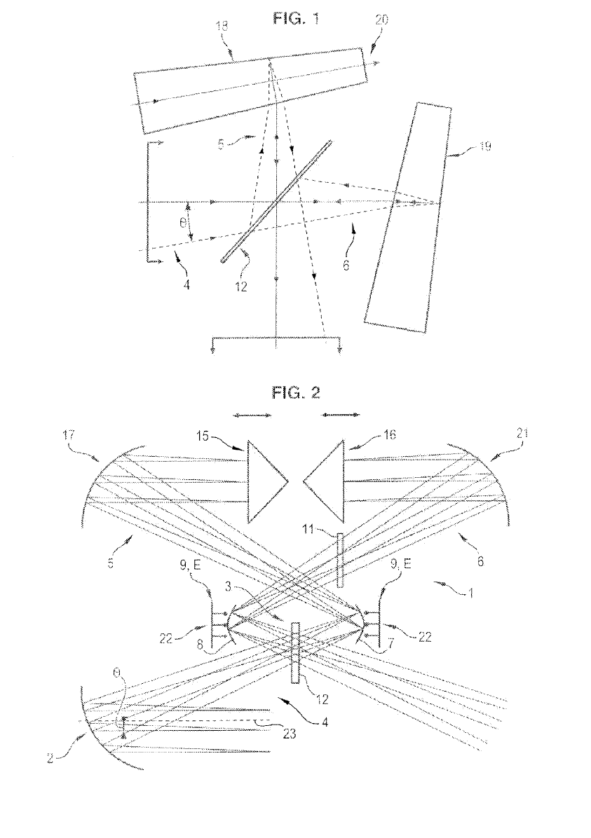

A field-compensated interferometer 1 according to the invention is illustrated in FIG. 2.

The interferometer 1 comprises an optical assembly 2, capable of directing the incident light beams 4, from the scene to be observed, into the arms 5, 6 of the interferometer 1 for generating a path difference which will be described later on.

This optical assembly 2 is generally a spherical mirror or an aspherical mirror, or a set of several mirrors of different types, on which the incident light beams 4 are reflected.

Given that the scene to be observed by the interferometer 1 is generally not a point-like spot, but a more or less extended area, certain incident light beams 4, have a non-zero field angle θ relative to an optical axis 23 of the interferometer 1, as this is illustrated in FIG. 2.

The incident light beams 4 which are parallel to the optical axis 23 of the interferometer 1 themselves have a field angle θ equal to zero.

The incident light beams 4, reflected by the optical assembly 2 then encounter a semi-reflective beam splitter 12 which separates each incident light beam 4 into two light beams of quasi-identical intensity.

This type of beam splitter may for example be obtained by depositing a thin layer of a metal (such as aluminium) or dielectric compound at the surface of a glass plate.

The beam splitter 12 therefore allows separation of each incident light beam 4 into two light beams into the arms 5, 6 of the interferometer, one of the arms 6 conventionally comprising a thin glass plate 11 known to the person skilled in the art under the name of compensator plate.

In order to be able to generate an interferogram, it is necessary that the light beams, stemming from the separation of each incident light beam 4 cover a different optical path in each arm 5, 6 of the interferometer.

For this purpose, the arms 5, 6 comprise at least one mechanically movable optical device 15, 16, the displacement of which is indicated by arrows in FIG. 2, with which it is possible to generate a variable optical path difference between the beams stemming from the separation of each incident beam 4 by the semi-reflective beam splitter 12.

Diverse types of mechanically movable optical devices may be used for generating the variable path difference.

In FIG. 2, a possible solution is illustrated with two mechanically movable optical devices 15, 16. In this solution, each arm 5, 6 comprises a retro-reflector cube corner 15, 16 which may be displaced on an axis parallel to the optical axis 23 of the interferometer 1. The light beams are collimated towards the cube corners 15, 16 via mirrors 17, 21. Each cube corner 15, 16 is movable on the optical axis 23 along two displacement directions, which, depending on the displacement direction, causes an advance or a delay in terms of a path difference.

The retro-reflector cube corners 15, 16 may be displaced by using two independent mechanisms, or by using a single mechanism with a pendular movement.

Of course it is possible to apply a solution where a single mechanically movable optical device is common to both arms 5, 6 of the interferometer 1. For example, both cube corners may be firmly secured together by placing them side by side “head to tail”, which allows displacement of only one mechanically movable optical device.

Another solution consists of using one or more movable mirrors in the arms of the interferometer 1.

The presence of at least one mechanically movable device 15, 16 therefore allows generation of an optical path difference 5 which may be varied by displacing the device 15, 16. The mechanically movable device 15, 16 is typically displaced over a distance of a few millimeters to a few centimeters, in order to generate an optical path difference δ′ in the same interval.

The recombination of the light beams separated previously by the semi-reflective beam splitter 12 and having a path difference allows generation of the interferogram, the intensity of which is periodically modulated depending on the generated path difference. Most often and as this is illustrated in FIG. 2, the semi-reflective beam splitter 12 is also used for recombining the beams.

As explained earlier, in the absence of an optical element allowing compensation for the path difference due to the field angle θ relative to the optical axis 23 of the interferometer 1, i.e. in the presence of self-apodization, the incident beams have a non-zero field angle θ and the incident beams having a zero field angle θ will have a different variable path difference function of θ.

Thus, in the absence of field compensation, the actual path difference δ generated in the interferometer 1 is written as:

δ=δ′ cos(θ)

The presence of the field angle θ therefore introduces a path difference expressed by the “cos θ” term.

In order to compensate the path difference resulting from the field angle θ, the field-compensated interferometer 1 according to the invention notably comprises:
at least one field compensation optical element E arranged in either one of the image focal planes of the optical assembly 2 combined relative to the beam splitter 12, on which the optical assembly 2 forms the image of the scene to be observed,
said element E comprising at least one curved surface 9 for generating a path difference between the incident beams having a non-zero field angle θ and the incident beams having a zero field angle θ compensating the path difference resulting from the field angle θ.
   The image focal planes of the optical assembly 2 in which is positioned the optical element E are combined relative to the beam splitter, which means that these focal planes are images of each other relatively to the beam splitter, as this is illustrated in FIG. 2.

In an advantageous embodiment of the invention, and as this will be described hereafter, the interferometer 1 comprises two field compensation optical elements E respectively arranged in each of the two image focal planes of the optical assembly 2 combined relatively to the beam splitter 12. The optical assembly 2 therefore forms the image of the scene to be observed on each of these two optical elements E for field compensation.

In an embodiment of the invention, the field compensation optical element E is a reflective mirror 7, 8 arranged on one of the image focal planes of the optical assembly 2 combined relative to the beam splitter 12.

The mirror 7, 8 comprises a curved reflective surface 9 on at least one of its meridians 13, in order to generate a path difference compensating the path difference due to the field angle θ.

Thus, the curvature of the reflective surface 9 is selected for introducing a compensation path difference δ_{E} which is written as:

δ_{E}=δ_{O}(1−cos(θ))

In this equation, θ_{O} is a free parameter which depends on the curvature which is given to the reflective surface 9 of the mirror 7, 8.

Accordingly, by means of the mirror 7, 8 ensuring field compensation, the actual path difference 6 generated in the interferometer 1 is now written as:

δ=δ′ cos(θ)+δ₀(1−cos(θ))<=>δ=δ₀+(δ′−δ₀)cos(θ).

Field compensation is total when the mechanical movable optical device 15, 16 is displaced for generating a path difference δ′ equal to δ₀, since, in this case, the actual path difference no longer depends on the field angle θ. The self-apodization phenomenon is then cancelled out.

For path differences δ′ different from δ₀, field compensation is also achieved, since the term of “cos(θ)” is modulated by the difference “δ′−δ₀”. In this case, the self-apodization phenomenon is reduced.

The selection of the value δ₀ corresponds to the selection of a preferential path difference δ₀ for which field compensation is total.

As the spectral resolution increases with the path difference generated by the mechanically movable optical device 15, 16, it is advantageous to select a high value for δ₀ which allows an increase in the spectral resolution.

According to another aspect of the invention, it is possible to use a field compensation optical element 5, the surface 9 of which is modified “in real time” for introducing the path difference δ_{E}(θ, δ′)=δ′(1−cos(θ)), this solution being described later on. In this case, the field compensation optical element E allows total compensation for the field, i.e. cancelling out self-apodization, for all the path differences δ′ generated via the mechanically movable device 15, 16.

The curvature of the reflective surface 9 on at least one of the meridians 13 of the mirror 7, 8 may be made by machining the surface 9 of the mirror 7, 8 continuously. In this case, the surface 9 of the mirror 5, 6 has a continuously curved mechanical profile on at least one of its meridians 13, the curvature of which follows the function δ_{E}=δ₀(1−cos(θ)).

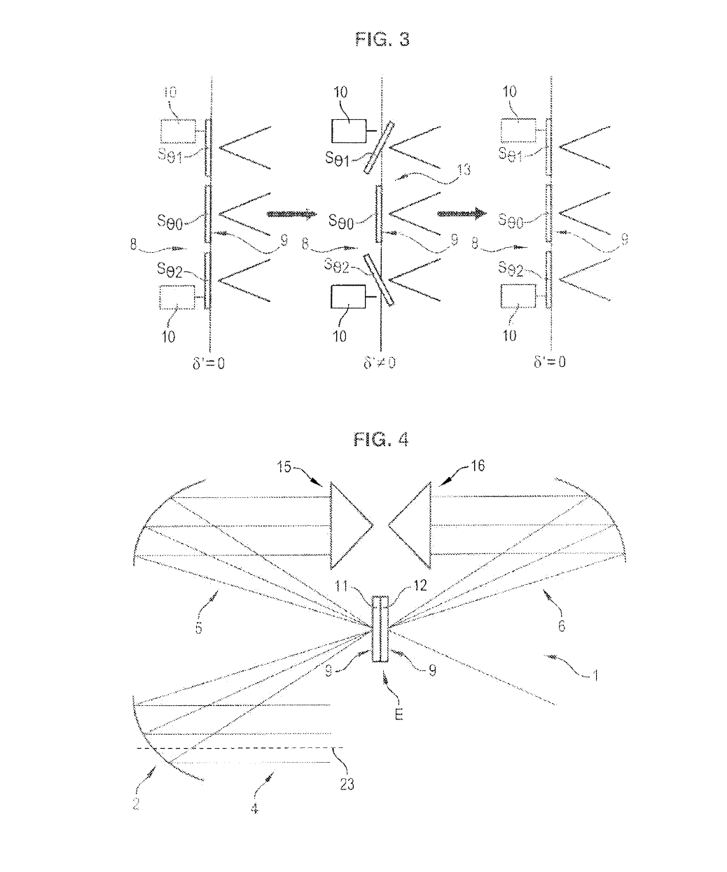

Another solution, illustrated in FIG. 3, consists of using a reflective curved surface 9 including a mechanical profile consisting of a discrete set of reflective planar surfaces (S_{θ0}, S_{θ1}, S_{θ2}, . . . ).

Thus, the incident light beams 4 having a field angle close to the value of θ₁ will be directed by the optical assembly 2 onto the surface S_{θ1}. The incident light beams 4 having a zero or quasi zero field angle θ₀, i.e. the light beams 4 close to the optical axis of the interferometer 1, will be directed onto the surface S_{θ0}.

The surface S_{θ1} is tilted relatively to the surface S_{θ0} in order to generate a compensation path difference δ_{E}(θ₁), which allows compensation for the path difference due to the non-zero field angle θ₁.

The same applies for the incident light beams 4 having a field angle close to the value of θ₂, which will be directed onto the surface S_{θ2} by the optical assembly 2, which is tilted relatively to the surface S_{θ0}.

As an example, the use of a mechanical profile consisting of a discrete set of reflective planar surfaces (S_{θ0}, S_{θ1}, S_{θ2}, . . . ) does not allow accurate following of the function δ_{E}=δ₀(1−cos(θ)), but already allows a satisfactory field compensation to be obtained, in many situations.

In practice, the use of three reflective planar surfaces (S_{θ0}, S_{θ1}, S_{θ2}) is sufficient for compensating for the field satisfactorily, i.e. reducing self apodization.

Moreover, as the incident light beams 4 may have a field angle θ relatively to the optical axis of the interferometer 1, in all the spatial directions, thereby following an axisymmetrical cone with an apex angle equal to θ around the optical axis 23 of the interferometer 1, the light beams affected by the optical assembly 2 will be linearly shifted on the surface 9 of the mirror 7, 8. This shift is notably performed on the surface 9 along both horizontal and vertical directions of said surface 9.

In order to be able to compensate for the field in all the spatial directions, the mirror 7, 8 advantageously has a curved surface 9, on two of its meridians orthogonal to each other. The curvature may be made by using a continuously curved or discrete mechanical profile, as explained earlier.

Another advantageous solution consists of using two mirrors 7, 8, each arranged in one of the arms 5, 6 of the interferometer, as illustrated in FIG. 2. Both mirrors 7, 8 are respectively arranged in each of the two image focal planes of the optical assembly 2, combined relative to the beam splitter 12.

In this case, it is advantageous to use one of the two mirrors 7 comprising a curved surface 9 on a first meridian, the other one of the two mirrors 8 comprising a curved surface 9 on a second meridian, the first and the second meridian being orthogonal.

Of course, it is possible to use two mirrors 7, 8 each having a curved surface 9 on each of the two meridians.

The use of a field compensation optical element E which is a reflective mirror 7, 8, has the advantage of proposing an achromatic solution. Indeed, field compensation is performed by reflection of incident light beams 4 on the mirror 7, 8 and not like in certain solutions of the prior art, by transmission over long distances in media of different refractive indexes.

Moreover, in the interferometer 1 according to the invention, the field compensation optical element E, which for example is the mirror 7, 8, is arranged at the image focal plane of the optical assembly 2, this is why the incident light beams 4 reflected by said assembly 2 towards the field compensation optical element E are caused to converge.

The arrangement of the field compensation optical element E may have a certain positioning error margin relative to the image focal plane of the optical assembly 2.

This configuration is very advantageous, since the fact that the light beams 4 are directed convergently towards the field compensation optical element E allows a reduction in the size of said field compensation optical element E.

Indeed, the field compensation is then carried out on convergent beams, more concentrated than parallel collimated beams.

It is thus possible to use as a field compensation optical element E, a mirror 7, 8 of compact size. In an interferometer 1 according to the invention, the mirror may for example have a size from a few millimeters to a few tens of millimeters.

Another advantage of the invention is that it allows an increase in the acceptable field angle θ in the interferometer, with which it is possible to obtain an instrument with a large field of view, without reducing the spectral resolution.

Also, it is possible to increase the angular aperture at the mechanically movable device 15, 16, such as for example the retro-reflector cube, which allows reduction in the linear size of said device and more generally a reduction in the bulkiness of the interferometer.

In an embodiment of the invention, a field compensation optical element E is used for totally compensating the field, i.e. canceling out self-apodization, for all the path differences δ′ generated via the mechanically movable device 15, 16.

The total canceling out of self-apodization for all the path differences requires the use of field compensation optical element E giving the possibility of obtaining a compensation path difference not only variable depending on the field angle θ, via the use of a curved surface 9 and as described earlier, but also variable depending on the path difference δ′. This optical element E should therefore introduce the path difference δ_{E} variable with δ′:

δ_{E}(θ,δ′)=δ′(1−cos(θ))

With such an optical element E, the actual path difference δ generated in the interferometer 1 no longer depends on the field angle θ, and is written as:

δ=δ′ cos(θ)+δ′(1−cos(θ))<=>δ=δ′

To do this, it is necessary to displace or deform the surface of the optical element E in real time, i.e. simultaneously with the displacement of the mechanically movable optical device 15, 16.

In an embodiment of the invention, and as illustrated in FIG. 3, for this purpose, means 10 are used for rotating the reflective planar surfaces (S_{θ1}, S_{θ2}, . . . ) of the mirror 7, 8, in order to generate a compensation path difference also variable as function of δ′.

The rotation means 10 pivot the reflective planar surfaces (S_{θ1}, S_{θ2}, . . . ). Pivoting may be achieved around any point of each of said reflective planar surfaces, such as for example the centre of said surface, or its end.

Each of the reflective planar surfaces (S_{θ1},S_{θ2}, . . . ) defines as many elementary portions of the image field. A rotation for which the amplitude is specific to each of said surfaces is applied to each of said surfaces (S_{θ1}, S_{θ2}, . . . ), in order to achieve optimum compensation for the variation of the path difference depending on δ′ and θ.

In the particular configuration illustrated in FIG. 3, the surface S_{θ0} is located at the centre of the image field and therefore does not need to be displaced, given that it corresponds to a zero or quasi zero field angle.

In a field-compensated interferometry method according to the invention, the reflective planar surfaces (S_{θ1}, S_{θ2}, . . . ) of the mirror 7, 8 are displaced in rotation simultaneously with the optical device 15, by an angle allowing compensation for the path difference generated by the displacement of the optical device 15, 16. Thus, the mirror 7, 8 introduces for each path difference δ′ generated by the optical device 15, 16 a compensation path difference approximating at best the function δ_{E}=δ′(1−cos(θ)).

The rotation is performed via rotation means 10, which are illustrated very schematically as functional blocks in FIG. 3.

More generally, it is possible to use other displacement means, such as means for translating reflective planar surfaces.

In another embodiment of the invention, a thin mirror 7, 8 and deformable via a deformation system 22 is used, as illustrated in FIG. 2.

This type of mirror may for example by deformed via a piezo-electric system 22 or a magnetic system 22, the mechanical and/or electrical and/or magnetic action of which gives the possibility of obtaining the desired deformation of the reflective surface 9 of the mirror 7, 8. Any other deformation system 22 known to the person skilled in the art may be used.

In a field-compensated interferometry method according to the invention, the surface 9 of the thin mirror 7, 8 is deformed simultaneously with the displacement of the optical device 15, 16, by a distance compensating for the path difference generated by the displacement of said optical device 15, 16. Thus, the mirror 7, 8 introduces for each path difference δ′ generated by the optical device 15, 16 a compensation path difference δ_{E}=δ′(1−cos(θ)). Given that the deformation of each point of the deformable mirror may be controlled, it is possible to obtain a very accurate compensation path difference δ_{E}.

Other solutions may of course be contemplated in order to displace the surface(s) of the mirror 7, 8 depending on the path difference δ′ generated by the displacement of the optical device 15, 16.

Advantageously, the displacement of the surfaces (S_{θ1}, S_{θ2}, . . . ) of the mirror 7, 8, or the deformation of the surface 9 of the deformable mirror 7, 8 is controlled via a laser metrology tool. This gives the possibility of checking that the desired compensation path difference δ_{E} is actually introduced.

It is clear that in the case when the rotation means 10 or the deformation system 22 are not used, the embodiment described earlier is again found, in which the field compensation optical element E, such as for example the mirror 7, 8, is fixed and a compensation path difference δ_{E}=δ₀(1−cos(θ)) is introduced, wherein δ₀ has a set value. By using the rotation means 10 or the deformation system 22, it is then possible to assign the desired value to the parameter δ₀.

The displacement of the deformation in real time of the surface(s) of the field compensation optical element E in the interferometer 1 according to the invention has many advantages, in addition to those already mentioned within the scope of the embodiment with a fixed element E.

An advantage of the invention is that it allows total compensation for the field, i.e. total canceling out of self-apodization, regardless of the path differences δ′. With the invention, it is possible to cause disappearance of the standard constraint of interferometers, and more generally of optical instruments which associate with a given spectral resolution an acceptable maximum field angle value, and vice versa.

By means of the invention, the spectral resolution of the interferometer is no longer only limited by the path difference δ′ which may be generated by the displacement of the optical device 15, 16, which is very advantageous.

Total compensation of the field produced by the invention therefore allows the use of interferometers having a very large acceptable field of view while preserving high spectral resolution.

Further, given that the field of view may be increased without reducing the spectral resolution, this allows increase in the luminosity, which depends on the incident light flux and therefore on the field of view, which increases the product between the spectral resolution and the luminosity. As the product of the spectral resolution by the luminosity defines the general efficiency of the interferometer, the invention therefore gives the possibility of increasing the efficiency of said interferometer.

In the embodiment using the fixed field compensation optical element E, it was mentioned that the invention allowed an increase in the angular aperture at the mechanically movable device 15, 16, such as for example the retro-reflector cube, which may allow reduction in the linear size of said device, and in the bulkiness of the interferometer. Total compensation of the field regardless of the path difference δ′ which may be generated by the displacement of the optical device 15, 16, gives the possibility of further reducing the size of said device, and therefore the bulkiness of the interferometer.

Another advantage of the invention is that it requires a small rotation of the surfaces (S_{θ1}, S_{θ2}, . . . ) of the field compensation obstacle element E, via rotation means 10. The order of magnitude of the rotation to be applied is of a few milliradians for current and typical applications.

An alternative embodiment of the invention is illustrated in FIG. 4, which uses a fixed field compensation optical element E, wherein the field compensation optical element E is a thin glass plate.

The thin glass plate 11 is arranged at the image focal plane of the optical assembly 2. At least one external surface 9 of the thin glass plate 11 is machined in a curved way, in order to generate a path difference compensating for the path difference due to the field angle θ.

Field compensation is accomplished in this embodiment by the variable thickness of the thin glass plate 11, which is crossed by the light beams 4 reflected by the optical assembly 2, which allows introduction of a compensation path difference δ_{E}.

Thus, the curvature of the external surface 9 of the thin glass plate 11 is selected in order to introduce a compensation path difference δ_{E} which is written, as already explained earlier, as:

δ_{E}=δ₀(1−cos(θ)).

The radius of curvature to be selected for the thin glass plate 11 is large, which implies that chromatism problems are negligible. The radius of curvature is typically of the order of several meters.

The thin glass plate 11 may advantageously have a curved surface 9 on two of its meridians orthogonal to each other.

As explained in the first embodiment, the positioning of the thin glass plate 11 at the image focal plane of the optical assembly 2, allows reduction in the size of said plate 11, since the light beams 4 converge thereto. Thus, the size of the plate 11 is typically comprised between 60 and 80 mm, which is highly compact.

Alternatively, it is possible to use as a field compensation optical element E, the beam splitter 12, of the semi-reflective type arranged at the image focal plane of the optical assembly 2. This beam splitter 12 differs from the thin glass plate 11 by the fact that a metal or dielectric compound has been deposited on said plate 12.

The beam splitter 12 is machined so as to have at least one curved external surface 9 for field compensation.

The beam splitter 12 may advantageously have a curved surface 9 on two of its meridians, orthogonal to each other.

In another further alternative, the interferometer 1 comprises two field compensation optical elements E, i.e. the thin glass plate 11 and the beam splitter 12, which are grouped and arranged at the image focal plane of the optical assembly 2. In this case, the image focal planes of the optical assembly 2 combined relative to said beam splitter 12 coincide, and the thin glass plate 11 and the beam splitter 12 will be arranged therein.

In this case, it is advantageous to use one of the two plates 11 comprising a curved surface 9 on a first meridian, the other one of the two plates 12 comprising a curved surface 9 on a second meridian, the first and the second meridian being orthogonal.

The advantage of the configuration using one or more plates as a field compensation optical element E is that the obtained interferometer 1 is compact. Indeed, the plates are of reduced sizes. Further, in this configuration, the number of optical elements to be used in the interferometer is reduced, and therefore its bulkiness.

The interferometer 1 according to the invention finds many applications in industry, fundamental or applied research, or any other field requiring an interferometer as described earlier.

The interferometer 1 according to the invention may for example be used within the scope of space missions for observing the Earth notably based on infrared spectrometric techniques. In this case, the interferometer 1 is loaded on-board a satellite for observing the earth. The instrument according to the invention is compact, which is advantageous for being loaded on a satellite. Moreover, it has a large acceptable field of view and substantial spectral resolution, so that it is possible to obtain very good instrumental performances, compatible with the requirements of missions for observing the Earth.

1. A field-compensated interferometer (1), comprising:
an optical assembly (2) capable of directing incident light beams (4) having a field angle θ relative to an optical axis of the interferometer (1) into arms (5, 6) of the interferometer,
a beam splitter (12),
the arms (5, 6) comprising at least one mechanically movable optical device (15, 16) for generating a variable optical path difference between beams stemming from the separation of each incident beam (4) via said beam splitter (12),
said interferometer (1) being characterized in that it comprises:
at least one field compensation optical element (E), arranged in either one of the image focal planes of the optical assembly (2) combined relative to the beam splitter (12),
said element (E) comprising at least one curved surface (9) so as to generate a path difference between the incident beams having a non-zero field angle and the incident beams having a zero field angle, the thereby generated path difference allowing compensation for self-apodization resulting from the field angle.

2. The interferometer according to claim 1, comprising two field compensation optical elements (E) respectively arranged in each of the two image focal planes of the optical assembly (2) combined relative to the beam splitter (12).

3. The interferometer according to one of claims 1 or 2, wherein the surface (9) of the optical element (E) is curved on at least one of its meridians (13).

4. The interferometer according to one of claims 1 to 3, comprising two optical elements (E),
one of the elements comprising a curved surface (9) on a first meridian,
the other one of the elements comprising a curved surface (9) on a second meridian,
the first and the second meridian being orthogonal.

5. The interferometer according to one of claims 1 to 4, wherein the element (E) is a mirror (7, 8), said mirror (7, 8) comprising a reflective curved surface (9) on at least one of its meridians (13).

6. The interferometer according to claim 5, wherein the reflective curved surface (9) has a continuously curved mechanical profile.

7. The interferometer according to claim 5, wherein the reflective curved surface (9) has a mechanical profile consisting of a discrete set of reflective planar surfaces (S_{θ0}, S_{θ1}, S_{θ2}, . . . ).

8. The interferometer according to claim 7, including means (10) for rotating the reflective planar surfaces (S_{θ0}, S_{θ1}, S_{θ2}, . . . ).

9. The interferometer according to one of claims 1 to 6, wherein the element (E) is a thin mirror (7, 8) and deformable via a deformation system (22).

10. The interferometer according to claim 9, wherein the deformation system (22) is a piezo-electric system.

11. The interferometer according to one of claims 7 to 10, comprising a laser metrology tool for controlling the displacement generated by the means (10) for displacement or deformation generated by the deformation system (22).

12. The interferometer according to one of claims 1 to 3, wherein the field compensation optical element (E) is a thin glass plate (11).

13. The interferometer according to one of claims 1 to 4, wherein the interferometer (1) comprises two field compensation optical elements (E): a thin glass plate (11) and the beam splitter (12), arranged in the image focal plane of the optical assembly (2).

14. A field-compensated interferometry method in an interferometer (1) according to one of claims 7, 8 or 11, wherein:
the optical assembly (2) directs the incident light beams (4), into the arms (5, 6) of the interferometer,
the mechanically movable optical device (15, 16) is displaced in order to generate a path difference between the beams stemming from the separation of each incident beam (4), the recombination of which allows application of interferometry,
said method being characterized in that it comprises the step according to which:
the reflective planar surfaces (S_{θ0}, S_{θ2}, . . . ) of the mirror (7, 8) are displaced in rotation is simultaneously with the optical device (15, 16) by an angle compensating the path difference generated by the displacement of said optical device (15, 16).

15. A field-compensated interferometry method in an interferometer (1) according to one of claims 8 to 10, wherein:
the optical assembly (2) directs the incident light beams (4) into the arms (5, 6) of the interferometer,
the mechanically movable optical device (15, 16) is displaced in order to generate a path difference between the beams stemming from the separation of each incident beam (4), the recombination of which allows application of interferometry,
said method being characterized in that it comprises the step according to which:
the surface (9) of the thin mirror (7, 8) is deformed simultaneously with the optical device (15, 16) by a distance compensating the path difference generated by the displacement of said optical device (15, 16).
